(19) United States
(12) Patent Application Publication
(10) Pub. No.: US 2008/0162204 A1
(43) Pub. Date: Jul. 3, 2008

(54) Tracking and management of logistical processes

(76) Inventors: John J. Kaiser, Dunlap, IL (US); Keith E. Thach, Dunlap, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/646,365

(22) Filed: Dec. 28, 2006

(51) Int. Cl. G06Q 10/00

(52) U.S. Cl. 705/7

(57) ABSTRACT

A method is provided for managing a plurality of processes associated with a supply chain network. The method may include accumulating performance data relating to each of the plurality of processes and comparing the accumulated performance data against a predetermined threshold value. The method may also include assigning a performance indicator to the plurality of processes based on the comparison between the accumulated performance data and the predetermined threshold value. The method may further include displaying a first detail level of data relating to the accumulated performance data, and displaying a second detail level of data relating to the accumulated performance data, the second detail level being different from the first detail level.

### TECHNICAL FIELD

The present disclosure relates to supply chain management and, more particularly, to tracking, measuring, and evaluating the current performance of logistical processes in a supply chain network.

### BACKGROUND

Due to increased competition, today's fast-paced global economy has forced many businesses to operate and conduct business in an ever increasingly efficient manner. Thus, inefficiencies that were once tolerated by corporations, due to a prior parochial nature of customers and suppliers, now have to be removed or mitigated so that the respective corporations can effectively compete in today's vastly dynamic marketplace. Accordingly, such corporations have relied on the rapidly growing field of supply chain management to plan, implement, and control, among other things, the efficient flow, storage, and utilization of resources, such as, for example, goods, services, and/or human capital, from start locations to consumption points in a manner that conforms to business-specific requirements.

Logistical processes, such as, for example, manufacturing, packaging, shipping, and/or warehousing, frequently form critical links of supply chain networks. Thus, the ability to effectively monitor, track, measure, and/or analyze the performance of such processes can be critical to optimizing the planning, execution, and collaboration of services dependent upon such supply chain networks. In order to do so, many supply chain managers have turned to the adoption of comprehensive performance measures and/or metrics to aid in tracking and analyzing supply chain networks, both on a micro, process level and on a macro, supply chain management level. Indeed, assigning, tracking, and analyzing various comprehensive performance measures and/or metrics can generally lead to uncovering hidden performance improvement opportunities for many logistical processes and networks. However, the compilation, comparison, and analysis of such measures and/or metrics can be difficult and time-consuming tasks for even the most skilled supply chain managers.

Difficulty in managing and analyzing performance data has been addressed in the art by enabling networks to capture, integrate, measure, monitor, analyze, and publish actual performance data stored in multiple sources, and display the grouped results in a convenient and efficient manner through a single user interface. For instance, the use of such an interface is described in U.S. Patent Publication No. 2002/0116213 published on Aug. 22, 2002, to Kavounis et al. Specifically, the Kavounis et al. publication discloses a system and method for retrieving and processing data stored in disparate network applications and displaying the processed data through a single user interface. While such an interface can provide businesses with the ability of compiling and analyzing large amounts of data stored on incompatible systems, the Kavounis et al. system and method do not provide for up-to-date supply chain and process tracking and evaluation, and consequently, do not allow for up-to-date reallocation of resources. Accordingly, providing a system and method that is capable of tracking and evaluating performance of individual logistical processes in a manner that allows for up-to-date reallocation of resources within a supply chain network has been problematic and elusive.

The present disclosure is directed to overcoming one or more of the shortcomings set forth above.

### SUMMARY OF THE INVENTION

In one aspect, the present disclosure is directed to a method for managing a plurality of processes associated with a supply chain network. The method may include accumulating performance data relating to each of the plurality of processes and comparing the accumulated performance data against a predetermined threshold value. The method may also include assigning a performance indicator to the plurality of processes based on the comparison between the accumulated performance data and the predetermined threshold value. The method may further include displaying a first detail level of data relating to the accumulated performance data, and displaying a second detail level of data relating to the accumulated performance data, the second detail level being different from the first detail level.

In another aspect, the present disclosure is directed to a computer readable medium containing programming instructions for evaluating the performance of a plurality of processes. The programming instructions may include accumulating performance data relating to each of the plurality of processes and comparing the accumulated performance data against a predetermined threshold value. The programming instructions may also include assigning a performance indicator to the plurality of processes based on the comparison between the accumulated performance data and the predetermined threshold value. The programming instructions may further include displaying a first detail level of data relating to the accumulated performance data, and displaying a second detail level of data relating to the accumulated performance data, the second detail level being different from the first detail level.

### BRIEF DESCRIPTION OF THE DRAWINGS

FIG. 1 is an exemplary diagrammatic illustration of a supply chain network having a plurality of logistical processes, in accordance with the present disclosure.

FIG. 2 is an exemplary diagrammatic illustration of a supply chain network for providing distribution of parts, in accordance with the present disclosure.

FIG. 3 is a flowchart of an exemplary method for tracking, measuring, and evaluating the performance of processes within a supply chain network.

FIG. 4A is an illustration of an exemplary screen-shot for viewing gathered performance information, in accordance with an embodiment of the present disclosure.

FIG. 4B is an illustration of an exemplary screen-shot for viewing selected details of the performance information displayed on the exemplary screen-shot of FIG. 4A.

FIG. 4C is an illustration of an exemplary screen-shot for viewing selected details of the performance information displayed on the exemplary screen-shot of FIG. 4B.

FIG. 4D is an illustration of an exemplary screen-shot for viewing selected details of the performance information displayed on the exemplary screen-shot of FIG. 4C.

FIG. 5A is an illustration of an exemplary screen-shot for viewing gathered performance information, in accordance with another embodiment of the present disclosure.

FIG. 5B is an illustration of an exemplary screen-shot for viewing selected details of the performance information displayed on the exemplary screen-shot of FIG. 5A.

FIG. 5C is an illustration of an exemplary screen-shot for viewing selected details of the performance information displayed on the exemplary screen-shot of FIG. 5B.

FIG. 5D is an illustration of an exemplary screen-shot for viewing selected details of the performance information displayed on the exemplary screen-shot of FIG. 5C.

FIG. 6 is a schematic illustration of an exemplary work environment for performing the method of FIG. 3.

### DETAILED DESCRIPTION

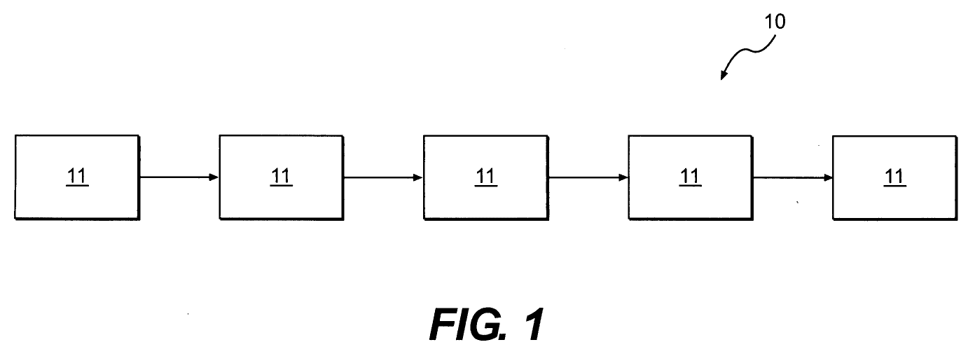

Referring now to FIG. 1, there is illustrated an exemplary supply chain network 10, in accordance with the present disclosure. Typically, a supply chain network may include the supply chain framework of an enterprise or a network of businesses, such as, for example, suppliers, customers, retailers, and the like, or a combination of those businesses. Supply chain network 10 may be utilized in any industry by any enterprise involved in providing services to a client. For discussion purposes only, the supply chain network 10 is described as the series of sequentially dependent logistical processes necessary to provide desired logistical services to a client. For example, supply chain network 10 may be a parts distribution network, which may be used to transport parts from a supplier, through a storage location such as, for example, a warehouse, and to a final destination such as, for example, a customer or dealer. Alternatively, supply chain network 10 may be a manufacturing process, which may include processes, such as, for example, molding, sawing, welding, and/or painting. As yet another alternative, supply chain network 10 may be utilized by a farming enterprise and may include processes, such as, for example, planting, fertilizing, picking, washing, and packaging. That is to say, one having ordinary skill in the art will readily recognize that the principles of this disclosure may be used with any logistical services network having a plurality of processes.

With continued reference to FIG. 1, supply chain network 10 may include a plurality of stages or processes 11. Although the exemplary supply chain network 10 is depicted as including five stages or processes, one skilled in the art will readily recognize that supply chain network 10 may include a greater or lesser number of processes 11, processes 11 may include any suitable logistical process, and processes 11 may be carried out in any order of the recited events which is logically possible, as well as the recommended and/or recited order of events.

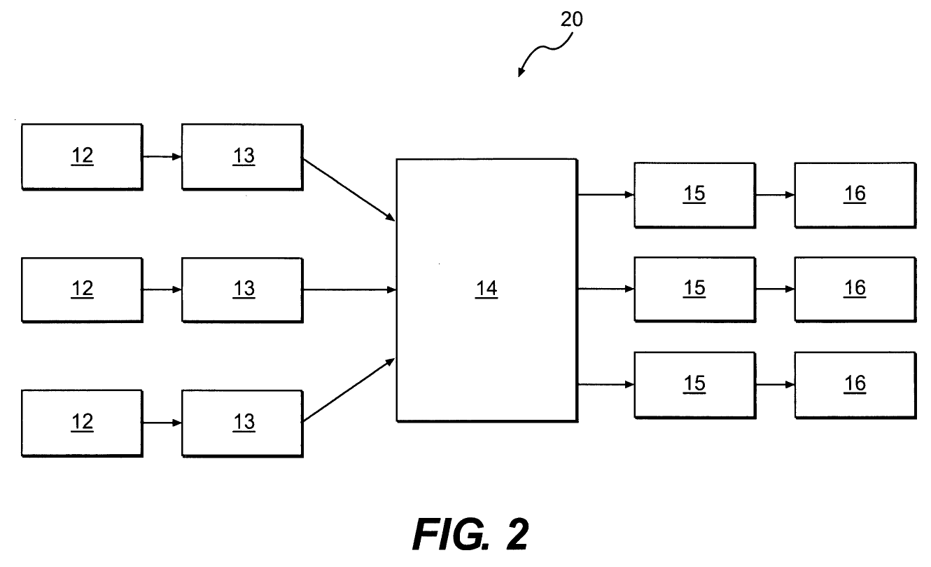

Turning to FIG. 2, there is illustrated an exemplary parts distribution supply chain network 20, in accordance with an embodiment of the present disclosure. Network 20 may include a plurality of sequentially dependent processes 12-15, which may include, but are not limited to, manufacturing, packaging, warehousing, transporting, cross-docking, sorting, and/or any other suitable processes known in the art. For the purposes of this disclosure, however, network 20 is depicted as including a supplier process 12, a transportation process 13, a warehouse process 14, and a second transportation process 15 that delivers an ordered part (not shown) to a destination 16, such as, for example, a customer, dealer, and/or distributor.

Specifically, supplier process 12 may include, for example, packaging of a part; transportation process 13 may include, for example, shipping of the packaged part; warehouse process 14 may include, for example, sorting received parts; and second transportation process 15 may include, for example, delivery of a part to a destination 16, such as, for example, a customer, dealer, and/or distributor.

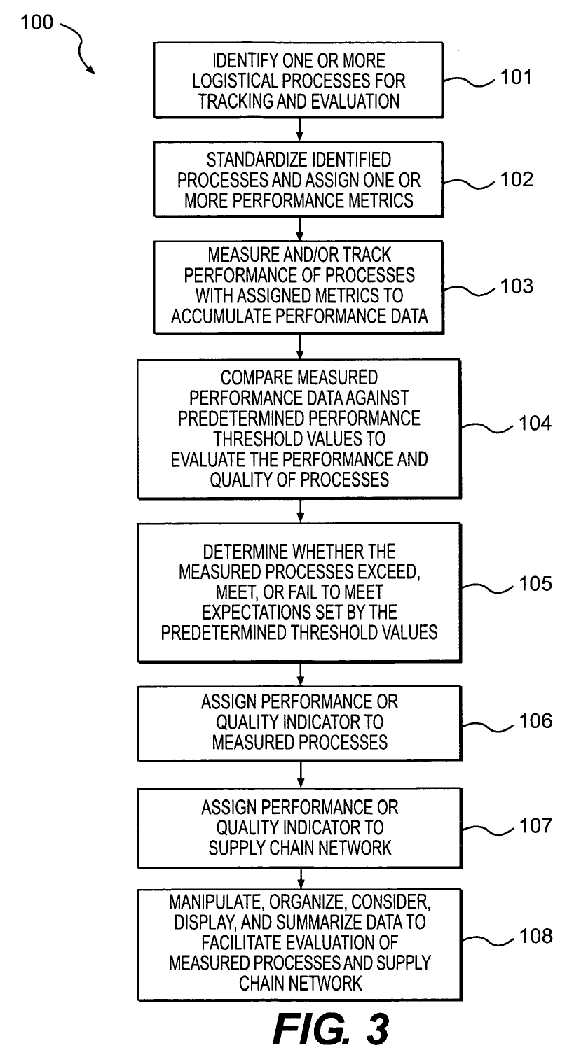

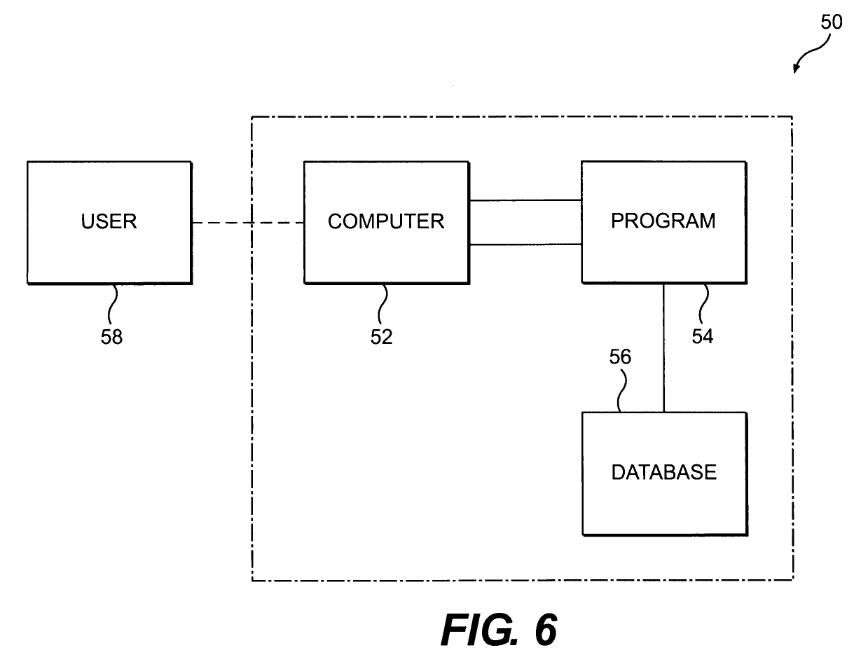

In accordance with an embodiment of the present disclosure, FIG. 3 illustrates an exemplary method 100 which may be performed by a system user, such as, for example, user 58 depicted in FIG. 6, to track, monitor, audit, and evaluate the current performance of logistical processes, such as, for example, processes 12-15 of supply chain network 20. System users may be any person or business unit associated with a supply chain network. Thus, a system user may be, for example, any person falling anywhere in a corporate hierarchy from top management down to an assembly line attendant.

As shown in FIG. 3, method 100 may include a plurality of steps 101-108. Specifically, method 100 may include identifying one or more logistical processes for evaluation and management, step 101. Method 100 may also include standardizing the processes identified in step 101, so that one or more tracking metrics may be assigned to the processes, step 102. Method 100 may also include accumulating performance data for each of the identified processes by measuring and/or tracking the performance of the identified processes with the assigned metric(s), step 103. Furthermore, method 100 may include comparing the accumulated performance data against predetermined performance threshold values, to evaluate the performance and quality of the tracked processes, step 104. Method 100 may further include determining whether the tracked processes exceed, meet, or fail to meet expectations set by the predetermined threshold values, step 105. Method 100 may also include assigning a performance (e.g., quality) indicator based on the comparison between the accumulated (e.g., measured) and predetermined threshold values, step 106. Method 100 may also include assigning a performance indicator to the entire supply chain network, based on the cumulative performance of each process within the network, step 107. Method 100 may further include manipulating, organizing, considering, displaying and/or summarizing data to facilitate evaluation of tracked processes and the supply chain network that includes those processes, step 108.

It is contemplated that method 100 may be performed continuously, periodically, singularly, as a batch method, and/or may be repeated as desired. Specifically, it is contemplated that method 100 may be utilized to evaluate the performance of each process within a supply chain network, and consequently, the performance of that supply chain network. It is also contemplated that one or more steps associated with method 100 may be selectively omitted, that the steps associated with method 100 may be performed in any order, and that the steps associated with method 100 are described in a particular sequence for exemplary purposes only.

With continuing reference to FIG. 3, step 101 may include, for example, identifying one or more logistical processes for tracking, monitoring, and/or evaluation. As set forth above, the principles of this disclosure provide for the tracking, monitoring, and/or evaluation of any logistical processes known in the art. For example, in the exemplary parts distribution network 20, method 100 may be used to evaluate the performance and quality of transportation process 13.

Next, step 102 of method 100 may include standardizing the identified processes in order to assign one or more tracking metrics. Standardizing of processes may include, for example, determining which properties of a particular process are relevant, variable, and/or controllable, and consequently, worthwhile of tracking and evaluating. Once a process has been standardized, one or more relevant performance metrics for tracking and evaluating the process may be assigned to that process. Performance metrics may include any desired parameter known in the art by which processes, such as, for example, process 13, may be tracked, measured, and evaluated. For example, performance metrics may include, but are not limited to, time, cost, velocity, quantity, quality, and capacity. One having ordinary skill in the art will readily recognize that the type and number of performance metric(s) selected may depend on the type of process being tracked.

Once the desired performance parameters for a process have been determined and the appropriate metrics have been assigned to that process, step 103 of method 100 may include accumulating current performance data by tracking the process and/or measuring the assigned metrics. It is contemplated that in some embodiments the accumulated performance data may also be historical and/or projected performance data. Tracking of logistical processes may be achieved by any suitable, appropriate manner known and utilized in the art. For example, parts may be tracked by scannable barcode or radio frequency identification (RFID) technology. Similarly, measurement of assigned performance metrics may be achieved by any suitable, appropriate manner known in the art. For example, measuring the velocity of a packaging process may include recording start and finish times of the process, and taking the difference of those times to determine the total time it took to complete the packaging process.

Next, step 104 of method 100 may include comparing the data accumulated in step 103 against predetermined performance thresholds, to evaluate the current performance and quality of the tracked process. The predetermined performance thresholds may be constant or may be set to vary, and may include, among other things, expected, targeted, and/or ideal (e.g., best-case) values. For example, the performance thresholds may include, but are not limited to, a targeted delivery date, transit time, or capacity, depending on the process and the metric being used to track that specific process. One having ordinary skill in the art will readily recognize that the type of performance threshold may depend upon the type of metric being used, which in turn may be dependent on the type of process being tracked. In at least some embodiments, it is contemplated that the predetermined threshold value may be determined and set by a system user through any suitable means known in the art. For example, predetermined values may be arbitrarily set, may be dictated by a customer, or may be based on historical data of the process being tracked or of similar processes. It is also contemplated that, in at least some embodiments, the predetermined values may be derived from previously measured performance data.

Step 105 may include determining whether the tracked processes exceed, meet, or fail to meet expectations set by the predetermined threshold values. Specifically, once the comparison of step 104 has been completed, step 105 may include categorizing tracked processes based on that comparison. For example, if the measured value of a specific performance metric equals the threshold value, it may be said that the process being tracked meets expectations or is being satisfactorily performed. Similarly, if the measured value of a performance metric is greater or less than the predetermined threshold value, it may be said that the process being tracked exceeds or fails to meet expectations, depending on the type of process being tracked and the performance metric used to track the process.

Next, step 106 may include selectively assigning the tracked processes a performance (e.g., quality) indicator based on whether the processes exceed, meet, or fail to meet the expectations set by a predetermined threshold value. Performance indicators may include, but are not limited to, numeric or alphabetical values, color codes, shapes, business-specific terminology, and/or any suitable, appropriate audio, visual, and/or tactile identifier known in the art. For example, a green color code may be assigned to processes that exceed expectations, a yellow color code may be assigned to processes that meet expectations, and a red color code may be assigned to processes that fail to meet expectations. It is contemplated that, in at least some embodiments, assignment of performance indicators may include placing certain information regarding the tracked process in a specific location, file, or directory on a computer or database.

Step 107 may include assigning a performance (e.g., quality) indicator to the overall supply chain network. Specifically, after steps 101-106 have been performed to track and evaluate the performance of the processes that make up a supply chain network, step 107, based on the cumulative performance of the tracked processes, may allow a user to assign an overall performance indicator to the entire network. One having ordinary skill in the art will readily recognize that the performance indicator for the supply chain network may be any suitable audio, visual, and/or tactile identifier known in the art, including those identified in the discussion of step 106 above. For example, assuming that all processes in a given supply chain network exceed predetermined expectations, that supply chain network may be assigned an indicator, such as, for example, a green color code, that communicates that the entire network is exceeding expectations. Alternatively, assuming that some processes of a given supply chain network may be exceeding expectations while other processes are failing to meet expectations, that network may be assigned an indicator, such as, for example, a yellow color code, that communicates that the entire network may be performing at a less than satisfactory level.

Step 108 may include one or more ways for a system user to selectively manipulate, organize, consider, and/or summarize information (e.g., performance indicators) relating to the tracked processes and supply chain network in a manner that facilitates evaluation of the tracked processes and/or the supply chain network that includes those processes, in order to determine whether reallocation of resources may be necessary. For example, step 108 may include displaying data relating to the accumulated performance data in one or more levels of detail. In addition, step 108 may allow the system user to selectively group together information relating to similar processes for different clients, accounts, or supply chain networks, to compare similar processes, and determine the performance of a specific type of logistical process. In addition, the user may selectively group together information relating to a plurality of supply chain networks that make up the framework for providing a logistical service, such that an overall performance of an enterprise's operations may be evaluated.

It is contemplated that system users may also selectively choose to view information in an aggregated format. For example, users may view data relating to the tracked processes and supply chain networks in a manner that allows for a higher level or global view of the metrics. That is to say, the system may allow users to view the aggregated data for the performance of all supply chain networks associated with a particular logistical service.

The system may also allow users to view data in a drill-down form. By drilling down, users view the data in exactly the opposite of what is accomplished in data aggregation. Instead of viewing data globally, users may view data in finer detail. Thus, it is contemplated that users may start by viewing high-level aggregate data and then penetrate down to analyze specific detail.

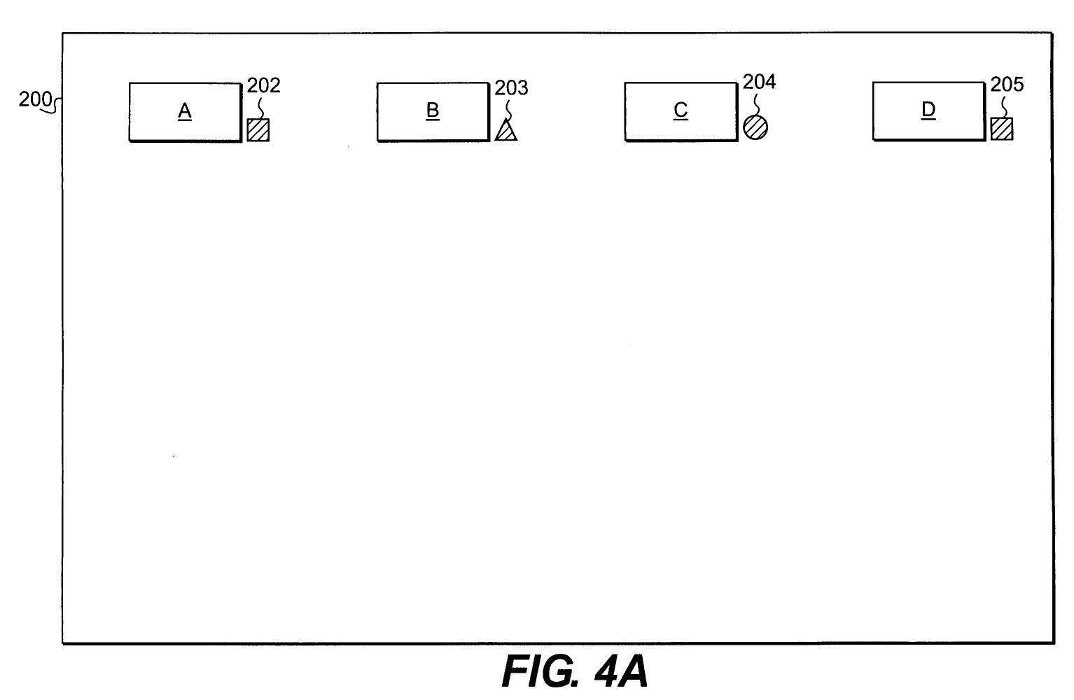

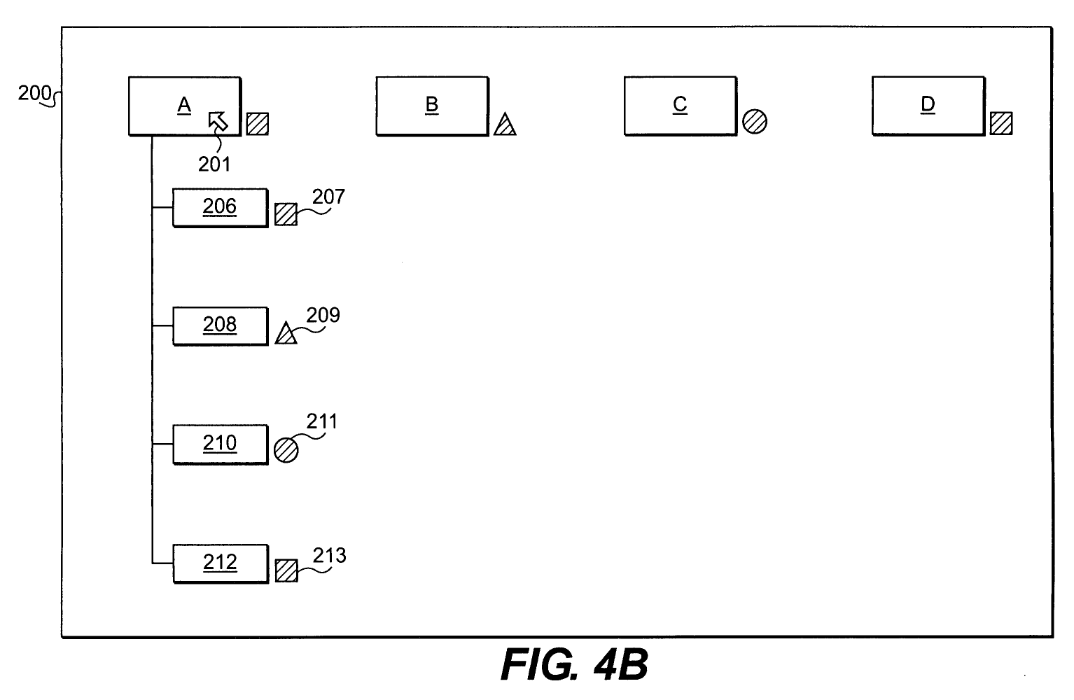

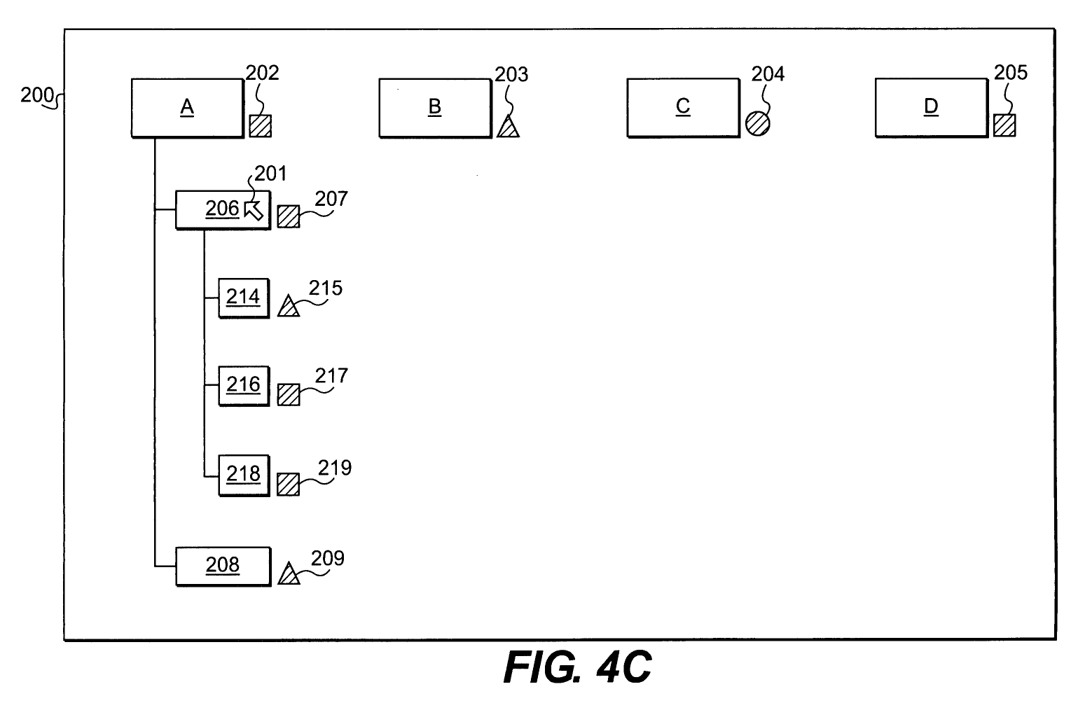

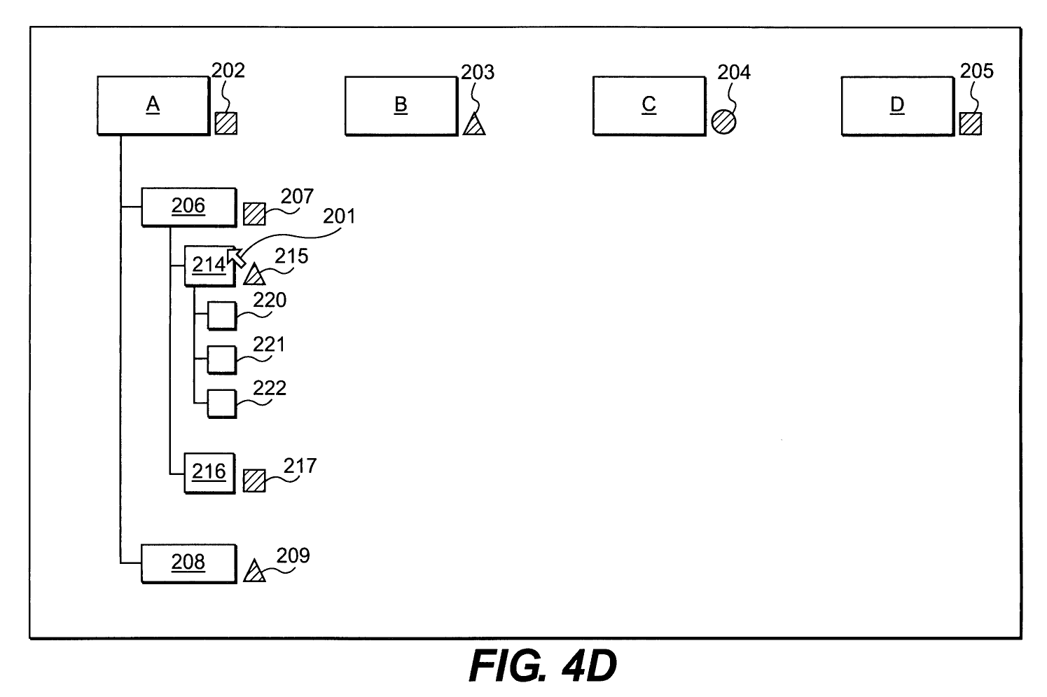

For example, a system user desiring to evaluate the performance of provided logistical services may begin by considering gathered performance data by viewing the performance of processes associated with a particular client or account. Specifically, the user may begin by viewing, for example, an output of a work environment, such as, for example, work environment 50 discussed below. As shown in FIG. 4A, such an output may include exemplary screen-shot 200, which includes graphical representations of the gathered performance data displayed on, for example, a monitor (not shown) of a work environment. Screen-shot 200 may depict information relating to a plurality of clients A, B, C, and D, and respective client services performance indicators 202-205, indicating the overall performance of processes associated with each client. Although screen-shot 200 depicts performance information relating to four clients, it will be readily apparent to those of ordinary skill in the art that screen-shot 200 may depict information relating to a greater or lesser number of clients.

Next, a system user desiring to view additional performance details for processes associated with a particular client, such as, for example, client A, may do so, for example, by using a suitable mechanism, such as, for example, mouse pointer 201, to instruct a work environment to display additional performance details for that client. As shown in FIG. 4B, additional performance details may include, but are not limited to, the performance details for facilities 206, 208, 210, and 212 where processes for a particular client are performed, and respective facility performance indicators 207, 209, 211, and 213.

Subsequently, a system user may view additional details by continuing the drill-down process. For example, a system user may again use mouse pointer 201 to instruct a work environment to display the performance details for a specific facility, such as, for example, facility 206, where processes are performed for a particular client. As shown in FIG. 4C, the additional performance details may include, but are not limited to, a listing of all processes, such as, for example, processes 214, 216, and 218, performed, and respective process performance indicators 215, 217, and 219 for each of the processes 214, 216, and 218. Although FIG. 4C depicts information relating to three processes, it will be readily apparent to those having ordinary skill in the art that a greater or lesser number of processes may be performed at a particular facility for a particular client.

Next, the system user may view even more performance details by continuing the drill-down process by using mouse pointer 201 to instruct a work environment to display, for example, details 220-222 of a particular process, such as, for example, process 214, as shown in FIG. 4D. Details 220-222 of a particular process may include, but are not limited to, the performance metric used to track the process, the predetermined performance threshold used to evaluate the process, and/or any performance measurements made while tracking the processes. Although FIG. 4D shows process 214 as having three details 220-222, one having ordinary skill in the art will readily recognize that process 214 may have a greater or lesser number of details.

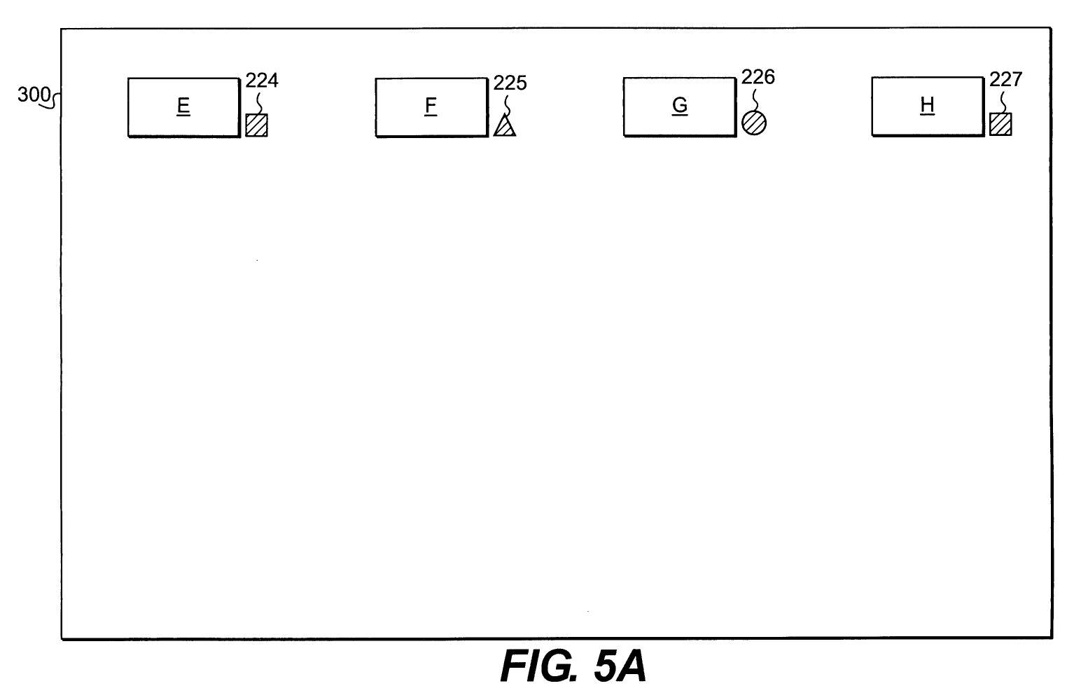

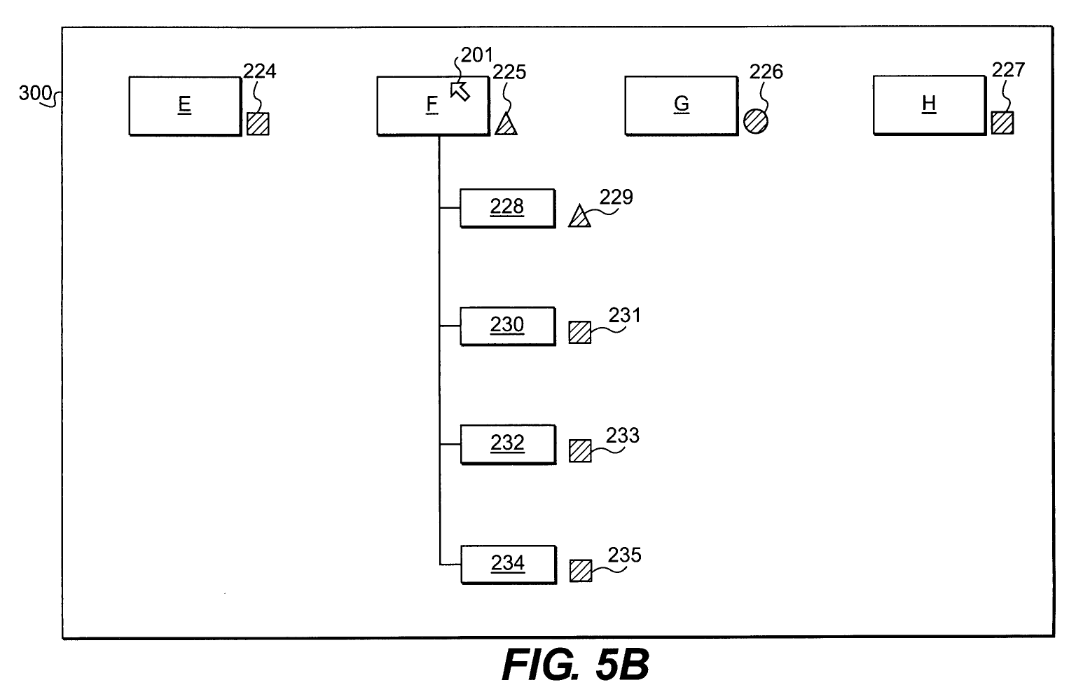

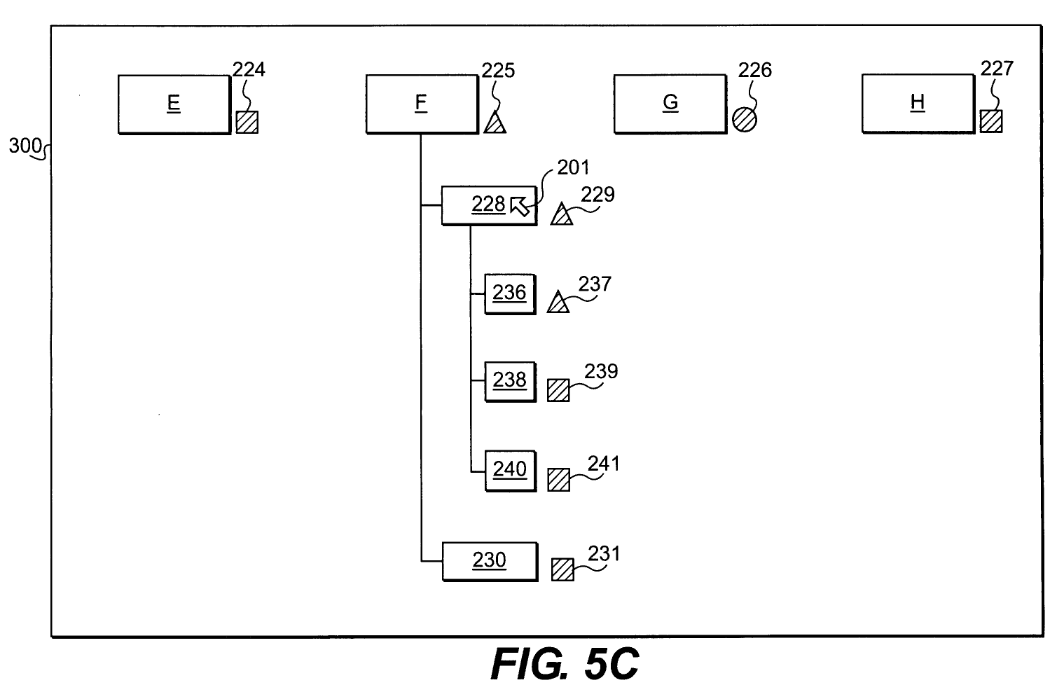

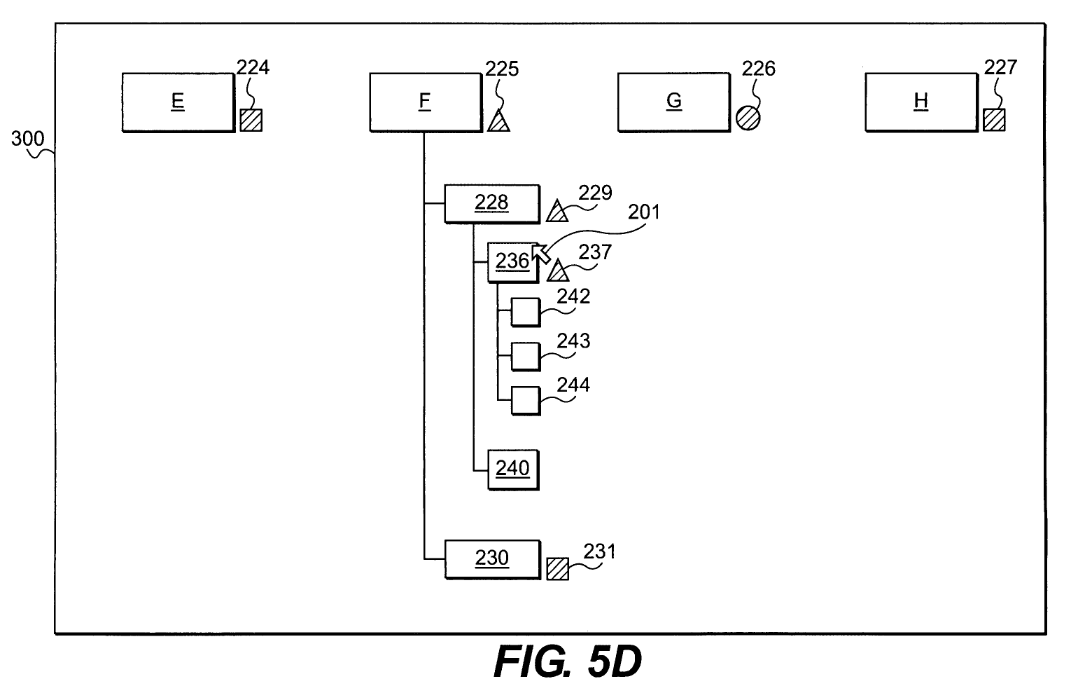

Alternatively, a system user may elect to evaluate gathered performance data by viewing the performance data for a particular type of process performed by an enterprise, regardless of whether the processes within a particular type belong to a common supply chain network or client. For example, the user may begin by viewing an output such as exemplary screen-shot 300. As shown in FIG. 5A, screen-shot 300 may depict information relating to a plurality of process types E, F, G, and H, and respective process-type performance indicators 224-227, indicating the performance of each type of logistical process performed. Although screen-shot 300 depicts performance information relating to four types of processes, it will be readily apparent to those of ordinary skill in the art that screen-shot 300 may depict information relating to a greater or lesser number of process types. Furthermore, as stated above, those with ordinary skill in art will readily recognize that process types E, F, G, and H may be any type of logistical processes known in the art, including, but not limited to, processes associated with order management, materials management, transportation management, distribution, compliance, logistics, and/or support.

Next, a system user desiring to view additional performance details for a specific type of processes, such as, for example, process type F, may do so by using mouse pointer 201 to instruct a work environment to display additional performance detail for that process type. As shown in FIG. 5B, additional performance details may include, but are not limited to, the performance details for facilities 228, 230, 232, and 234 where a particular type of processes are performed, and respective facility performance indicators 229, 231, 233, and 235.

Subsequently, the system user may continue the drill-down process to view additional performance details. For example, the user may again use mouse pointer 201 to instruct a work environment to display the performance details for a specific facility, such as, for example, facility 228, where a particular type of process is performed. As shown in FIG. 5C, the additional performance details may include, but are not limited to, a listing of all clients, such as, for example, clients 236, 238, and 240, for which a particular facility performs a particular type of process, and respective client performance indicators 237, 239, and 241.

Next, the system user may continue the drill-down process by using mouse pointer 201 to instruct a work environment to display exemplary details 242-244 for a particular client, such as, for example, client 236, as shown in FIG. 5D. Details 242-244 of a particular client may include, but are not limited to, historical performance data, resources allocated to that particular client, and/or types of processes associated with that particular client.

It is also contemplated that, in at least some embodiments, system users may search the performance data by criteria including, but not limited to, account (e.g., client), process type, metric type, facility, and/or supply chain network type.

Referring now to FIG. 6, there is illustrated an exemplary work environment 50 for performing method 100. Work environment 50 may include a computer 52, a program 54, and a database 56. Work environment 50 may be configured to accept inputs from a user 58 via computer 52 to track, monitor, and evaluate the performance of logistical processes of a supply chain network. Work environment 50 may be further configured to communicate and/or display data or graphics to user 58 via computer 52. It is contemplated that work environment 50 may include additional components such as, for example, a communications interface (not shown), a memory (not shown), and/or any other suitable components known in the art.

Computer 52 may include a general purpose computer configured to operate executable computer code. Computer 52 may include one or more input devices, such as, for example, a keyboard (not shown) or a mouse (not shown), to introduce inputs from user 58 into work environment 50 and may include one or more output devices, such as, for example, a monitor (not shown) to deliver outputs from the work environment 50 to a user 58. Specifically, user 58 may deliver one or more inputs, such as, for example, data, into work environment 50 via computer 52 to supply data associated with any of the steps of method 100 and/or to execute program 54. Computer 52 may also include one or more data manipulation devices, such as, for example, data storage or software programs (not shown), to transfer and/or alter user inputs. Computer 52 may also include one or more communication devices, such as, for example, a modem (not shown) or a network link (not shown), to communicate inputs and/or outputs with program 54. It is contemplated that computer 52 may further include additional and/or different components, such as, for example, a memory (not shown), a communications hub (not shown), a data storage (not shown), a printer (not shown), an audio-video device (not shown), removable data storage devices (not shown), and/or other components known in the art. It is also contemplated that computer 52 may communicate with program 54 via, for example, a local area network (“LAN”), a hardwired connection, and/or the Internet. It is further contemplated that work environment 50 may include any number of computers and that each computer associated with work environment 50 may be accessible by any number of users for inputting data into work environment 50, communicating data with program 54, and/or receiving outputs from work environment 50.

Program 54 may include a computer executable code routine provided on a computer readable medium containing programming instructions configured to perform one or more sub-routines and/or algorithms to track, monitor, and/or evaluate logistical processes within work environment 50. Specifically, program 54, in conjunction with user 58, may be configured to perform one or more steps of method 100. Program 54 may receive inputs, such as, for example, data, from computer 52 and perform one or more algorithms to manipulate the received data. Program 54 may also deliver one or more outputs, e.g., algorithmic results, and/or communicate via, for example, an electronic communication, the outputs to a user via computer 52. Program 54 may also access database 56 to locate and manipulate data stored therein to arrange and/or display stored performance data to user 58 via computer 52 via, for example, an interactive object oriented computer screen display and/or a graphical user interface. It is contemplated that program 54 may be stored within the memory (not shown) of computer 52 and/or stored on a remote server (not shown) accessible by computer 52. It is also contemplated that program 54 may include additional sub-routines and/or algorithms to perform various other operations with respect to mathematically representing data, generating or importing additional data into program 54, and/or performing other computer executable operations. It is further contemplated that program 54 may include any type of computer executable code, such as, for example, C++, and/or may be configured to operate on any type of computer software.

Database 56 may be configured to store and arrange data and to interact with program 54. Specifically, database 56 may be configured to store a plurality of data, such as, for example, data associated with any steps of method 100. Database 56 may store and arrange any quantity of data arranged in any suitable or desired format. Program 54 may be configured to access database 56 to identify particular data therein and display such data to a user. It is contemplated that database 56 may include any suitable type of database such as, for example, within a hierarchy or taxonomy, in groupings according to associated documents, and/or searchable according to associated identity tags. It is also contemplated that database 56 may include a single database and/or any number of databases.

### INDUSTRIAL APPLICABILITY

As eluded to above, the method and system of the present disclosure are generally applicable to any logistical process of any supply chain network in any industry. Method 100 may be utilized to identify, monitor, manage, and evaluate one or more processes of a supply chain network, in order to improve the overall performance of the network. The operation of method 100 is described below with respect to the parts distribution network 20 of FIG. 2 for exemplary purposes only and it is understood that method 100 is applicable to any type of process in any supply chain network in any industry.

A system user, such as, for example, a supply chain manager, may desire to assess the performance of his/her supply chain network, such as, for example, network 20. Accordingly, the user may identify one or more logistical processes within the network (step 101) for tracking and evaluation. With reference to FIG. 2, the user may choose to evaluate, for example, second transportation process 15, which may include, but is not limited to, the delivery of parts to a customer by ground transport.

Next, the user may standardize the identified process (step 102) in order to assign one or more relevant performance metrics for tracking and evaluating the identified process. For example, the user may choose to evaluate second transportation process 15 by monitoring the velocity of that process. Once the user has determined that the velocity of process 15 is to be tracked and measured, the user may measure and track the actual velocity of process 15 by any suitable means known in the art (step 103). The accumulated performance data may be entered into work environment 50 manually, automatically, or through a combination of those modes. Furthermore, the user may determine and input into work environment 50 data relating to predetermined performance threshold values against which the measured performance data will be compared. For example, the user may look to historical data of processes similar to process 15 and estimate the expected and/or targeted velocity of process 15.

Subsequently, the user may obtain a comparison between the accumulated and threshold (e.g., expected) values (step 104) to evaluate the performance and/or quality of the tracked process. Based on that comparison, the user may obtain a determination of whether the tracked process exceeds, meets, or fails to meet the expectations set by the predetermined threshold value (step 105). For exemplary purposes only, assuming the user has estimated that second transportation process 15 should take twenty-two hours to complete, and process 15 has been measured to take twenty hours from start to finish, process 15 would be deemed as exceeding the expectations set by the threshold value (i.e., the estimated time for completion), because the actual time measured was found to be less than the expected time for that process. Next, based on whether the tracked process exceeds, meets, or fails to meet the expectations set by the predetermined threshold value, a performance indicator, such as, for example, a color code, may be assigned to the tracked process (step 106), so that the user may quickly determine the quality of that process. For example, since exemplary process 15 above has been deemed to exceed the expectations set by the predetermined threshold value, process 15 may be assigned a green color code.

Once quality indicators have been assigned to all processes that were tracked, a system user may obtain an overall performance indicator for the supply chain network that includes the tracked processes (step 107). For example, if, like process 15, all processes in network 20 were determined to be exceeding expectations, network 20 may also be assigned a green color code, to indicate that the overall performance of network 20 may be exceeding expectations. Alternatively, if one or more processes in network 20 were determined to be failing to meet expectations, network 20 may be assigned a red color code, to indicate that the overall performance of the network may be failing to meet expectations. Still alternatively, if one or more processes in network 20 were previously deemed as failing to meet expectations but are being rectified, network 20 may be assigned a yellow color code, to indicate that while the overall performance of the network may be failing to meet expectations, the problems associated with the network are being addressed.

Next, the user may choose to manipulate, organize, consider, and/or summarize the performance data (e.g., performance indicators) in any of a number of ways (step 108). Specifically, data relating to the accumulated performance data may be first displayed in an aggregated format. Next, a user may drill down from a macro, operations level display to a micro, process level display. The user may also choose to search the performance data by any of a number of criteria including, but not limited to, process, metric, and/or account (e.g., client).

For example, with reference to FIGS. 4A-4D, the system user may elect to begin by viewing performance data for all logistical processes involved with providing services to a selected group of clients. Upon viewing such information on, for example, screen-shot 200 depicted in FIG. 4A, the user may choose to tunnel or drill-down through the data in order to view additional performance details for a particular client, such as, for example, client A, as set forth above. By doing so, the user may go, for example, step-wise, from a global view of performance details to a more detailed view of performance details associated with a particular client. Particularly, in response to a specific performance (or quality) indicator, the user may drill-down through the gathered performance data to identify the cause of that performance indicator. Although it is contemplated that the system user may use the above-described technique for considering performance data to identify problems within a supply chain network, the user may use the same technique to identify processes that are being performed at a level that exceeds expectations.

Alternatively, with reference to FIGS. 5A-5D, the system user may elect to begin by viewing performance data for a selected group of process types. Upon viewing such information on, for example, screen-shot 300 depicted in FIG. 5A, the user may choose to tunnel or drill-down through the data in order to view additional performance details for a particular type of processes, as set forth above. Again, by doing so, the user may go, for example, step-wise, from a global view of performance details to a more detailed view of performance details associated with a particular process type.

As yet another alternative, a system user may begin analyzing the performance of an enterprise's operations by viewing performance data for all supply chain networks associated with a particular logistical service. Next, assuming the user identifies a specific supply chain network with a less than satisfactory performance indicator, the user may drill-down through the performance data of that network, to identify which process in the network may be the cause for the less than satisfactory performance. Once the specific process has been identified, the user may view performance data relating to that specific process. For example, the user may see the specific metric that yielded a less than satisfactory performance indication.

It will be apparent to those skilled in the art that various modifications and variations can be made to the systems and methods of the present disclosure without departing from the scope of the disclosure. In addition, other embodiments will be apparent to those skilled in the art from the consideration of the specification and practice of the systems and methods disclosed herein. It is intended that the specification and examples be considered as exemplary only, with a true scope of the disclosure being indicated by the following claims and their equivalents.

What is claimed is:

1. A method for managing a plurality of processes associated with a supply chain network, the method comprising:
accumulating performance data relating to each of the plurality of processes;
comparing the accumulated performance data against a predetermined threshold value;
assigning a performance indicator to the plurality of processes based on the comparison between the accumulated performance data and the predetermined threshold value;
displaying a first detail level of data relating to the accumulated performance data; and
displaying a second detail level of data relating to the accumulated performance data, the second detail level being different from the first detail level.

2. The method of claim 1, wherein the first detail level of data allows a user to evaluate the aggregated performance of the supply chain network.

3. The method of claim 1, wherein the method further comprises:
determining whether the performance of each of the plurality of processes exceeds, meets, or fails to meet the predetermined threshold value.

4. The method of claim 1, wherein accumulating performance data includes accumulating current performance data.

5. The method of claim 1, wherein displaying the first detail level of data relating to the accumulated performance data includes grouping together processes and displaying an associated performance indicator for those processes.

6. The method of claim 5, wherein the processes are grouped together by client.

7. The method of claim 5, wherein the processes are grouped together by process type.

8. The method of claim 6, wherein displaying the second detail level of data includes grouping together processes performed at a particular facility for the client and displaying an associated performance indicator for those processes.

9. The method of claim 7, wherein displaying the second detail level of data relating to the accumulated performance data includes grouping together processes of the process type that are performed at a particular facility and displaying an associated performance indicator for those processes.

10. The method of claim 1, wherein accumulating performance data relating to each of the plurality of processes comprises:
assigning at least one performance metric to the plurality of processes; and
tracking the current performance of each of the plurality of processes with the assigned at least one performance metric.

11. The method of claim 10, wherein the at least one performance metric includes one of time, cost, velocity, quantity, quality, and capacity.

12. The method of claim 5, wherein displaying the first detail level of data relating to the accumulated performance data includes representing a group of processes as an icon on a flowchart and displaying an associated performance indicator proximate the icon for the group.

13. The method of claim 1, wherein the method further comprises:
displaying a third detail level of data relating to the accumulated performance data, the third detail level displaying details of selected data displayed in the second detail level.

14. The method of claim 13, wherein the method further comprises:
displaying a fourth detail level of data relating to the accumulated performance data, the fourth detail level displaying details of selected data displayed in the third detail level.

15. A computer readable medium containing programming instructions for evaluating the performance of a plurality of processes, the programming instructions comprising:
accumulating performance data relating to each of the plurality of processes;
comparing the accumulated performance data against a predetermined threshold value;
assigning a performance indicator to the plurality of processes based on the comparison between the accumulated performance data and the predetermined threshold value;
displaying a first detail level of data relating to the accumulated performance data; and
displaying a second detail level of data relating to the accumulated performance data, the second detail level being different from the first detail level.

16. The medium with the programming instructions of claim 15, wherein the programming instructions further comprise:
determining whether the performance of each of the plurality of processes exceeds, meets, or fails to meet the predetermined threshold value.

17. The medium with the programming instructions of claim 15, wherein displaying the first detail level of data relating to the accumulated performance data includes grouping together processes and displaying an associated performance indicator for those processes.

18. The medium with the programming instructions of claim 17, wherein the processes are grouped together by one of process type and client.

19. The medium with the programming instructions of 18, wherein displaying the second detail level of data includes further grouping together processes by facility and displaying an associated performance indicator for those processes.

20. The medium with programming instructions of claim 15, wherein displaying the first detail level of data relating to the accumulated performance data includes representing a group of processes as an icon on a flowchart and displaying an associated performance indicator proximate the icon for the group.
